(19) United States
(12) Patent Application Publication
(10) Pub. No.: US 2025/0085007 A1
(43) Pub. Date: Mar. 13, 2025

(54) Method for Determining Parameters of HVAC System, Computer-Readable Storage Medium, and Electronic Device

(71) Applicant: AIRSYS Refrigeration Engineering Technology (Beijing) Co., Ltd., Beijing (CN)

(72) Inventors: Yunshui CHEN, Beijing (CN); Guangchao WANG, Beijing (CN)

(21) Appl. No.: 18/437,068

(22) Filed: Feb. 8, 2024

(30) Foreign Application Priority Data
Sep. 13, 2023 (CN) 202311184183.2

(51) Int. Cl. F24F 11/46; F24F 11/77; F24F 120/14

(52) U.S. Cl. CPC F24F 11/46; F24F 11/77; F24F 2120/14

(57) ABSTRACT

The present disclosure discloses a method for determining parameters of an HVAC system, a computer-readable storage medium, and an electronic device. The method includes: determining a region area of a target indoor region; obtaining an object number and an activity intensity of at least one object in the target indoor region by a UWB radar sensor; determining an overall demand of the HVAC system for outdoor ventilation based on the region area and the object number and the activity intensity of the at least one object; and determining operational parameters of the HVAC system based on the overall demand. The present disclosure solves the technical problem of inaccuracy when the HVAC system obtains indoor control requirements of a building in related art.

### CROSS-REFERENCE TO RELATED APPLICATIONS

The disclosure claims priority to Chinese patent application No. 202311184183.2 filed to the China National Intellectual Property Administration on Sep. 13, 2023 and entitled “Method for Determining Parameters of HVAC System, Computer-Readable Storage Medium, and Electronic Device”, the disclosure of which is hereby incorporated by reference in its entirety.

### PRIOR ART

The present disclosure relates to the field of air conditioning control, and specifically to a method for determining parameters of an HVAC system, a computer-readable storage medium, and an electronic device.

### BACKGROUND OF THE INVENTION

Heating ventilation and air conditioning (HVAC) systems play an important role in existing building energy conservation systems. However, conventional HVAC systems often operate based on preset schedules and fixed parameters that cannot be flexibly adjusted according to actual demands, resulting in energy waste and unnecessary costs. In order to know an indoor condition of a building controlled by an HVAC system and determine control parameters of the HVAC system based on the condition to implement flexible adjustment according to requirements, there are many ways to try in related art. In the first way, the indoor condition of the building is photographed to obtain an image, and indoor control requirements of the building are analyzed based on the acquired image, but this way may lead to an inaccurate analysis result because the image acquisition is affected by an environment. In the second way, the concentration of indoor gas in the building is monitored, and indoor control requirements of the building are determined based on the monitored concentration, but this way also easily leads to an inaccurate analysis result because the gas monitoring is also susceptible to a gas environment.

Therefore, there is a problem of inaccuracy when the HVAC system obtains the indoor control requirements of the building in the related art.

In view of the above problem, no effective solutions have yet been proposed at present.

### SUMMARY OF THE INVENTION

Embodiments of the present disclosure provide a method for determining parameters of an HVAC system, a computer-readable storage medium, and an electronic device, to solve at least the technical problem of inaccuracy when the HVAC system obtains indoor control requirements of a building in related art.

According to an aspect of the embodiments of the present disclosure, a method for determining parameters of an HVAC system is provided, including: determining a region area of a target indoor region; obtaining an object number and an activity intensity of at least one object in the target indoor region by a UWB radar sensor; determining an overall demand of the HVAC system for outdoor ventilation based on the region area and the object number and the activity intensity of the at least one object; and determining operational parameters of the HVAC system based on the overall demand.

As at least one alternative embodiment, the determining an overall demand of the HVAC system for outdoor ventilation based on the region area and the object number and the activity intensity of the at least one object includes: determining a required indoor ventilation amount of the target indoor region based on the region area and the object number and the activity intensity of the at least one object; and determining the overall demand of the HVAC system for the outdoor ventilation based on the required indoor ventilation amount.

As at least one alternative embodiment, the determining the overall demand of the HVAC system for the outdoor ventilation based on the required indoor ventilation amount includes: determining a ventilation efficiency based on an operating mode of the HVAC system; and determining the overall demand of the HVAC system for the outdoor ventilation based on the ventilation efficiency and the required indoor ventilation amount.

As at least one alternative embodiment, the determining a required indoor ventilation amount of the target indoor region based on the region area and the object number and the activity intensity of the at least one object includes: obtaining an area-based required first ventilation amount based on the region area; obtaining an object-based required second ventilation amount based on the object number and the activity intensity of the at least one object; and determining the required indoor ventilation amount of the target indoor region based on the first ventilation amount and the second ventilation amount.

As at least one alternative embodiment, the obtaining an area-based required first ventilation amount based on the region area includes: determining a first ventilation rate corresponding to the region area; and obtaining the area-based required first ventilation amount based on the first ventilation rate and the region area.

As at least one alternative embodiment, the obtaining an object-based required second ventilation amount based on the object number and the activity intensity of the at least one object includes: determining a second ventilation rate corresponding to the object number; and obtaining the object-based required second ventilation amount based on the second ventilation rate and the object number and the activity intensity.

As at least one alternative embodiment, the obtaining an activity intensity of at least one object in the target indoor region by a UWB radar sensor includes: obtaining a target heart rate of the at least one object in the target indoor region by the UWB radar sensor; and determining the activity intensity of the at least one object in the target indoor region based on the target heart rate and a predetermined reference heart rate.

According to another aspect of the present disclosure, an apparatus for determining parameters of an HVAC system is provided, including: a first determination module, configured to determine a region area of a target indoor region; an obtaining module, configured to obtain an object number and an activity intensity of at least one object in the target indoor region by a UWB radar sensor; a second determination module, configured to determine an overall demand of the HVAC system for outdoor ventilation based on the region area and the object number and the activity intensity of the at least one object; and a third determination module, configured to determine operational parameters of the HVAC system based on the overall demand.

According to another aspect of the present disclosure, a computer-readable storage medium is provided, including a stored executable program, where the executable program, when run, controls a device where the computer-readable storage medium is located to perform any one of the above methods for determining parameters of an HVAC system.

According to another aspect of the present disclosure, an electronic device is provided, including: a memory storing an executable program; and a processor configured to run the program, where the program, when run, performs any one of the above methods for determining parameters of an HVAC system.

In the embodiments of the present disclosure, the region area of the target indoor region is determined; the object number and the activity intensity of the at least one object in the target indoor region are obtained by the UWB radar sensor; the overall demand of the HVAC system for the outdoor ventilation is determined based on the region area and the object number and the activity intensity of the at least one object; and the operational parameters of the HVAC system are determined based on the overall demand. The object number and the activity intensity of the at least one object are obtained by the UWB radar sensor. The UWB radar sensor has the characteristics of precise acquisition and fast response. Therefore, applying the UWB radar sensor to control on the HVAC system effectively implements precise on-demand control on the HVAC system, thereby achieving the technical effects of avoiding energy waste and reducing control costs while meeting comfort requirements of people, and solving the problem of inaccuracy when the HVAC system obtains indoor control requirements of a building in related art.

### BRIEF DESCRIPTION OF DRAWINGS

The accompanying drawings described herein are used to provide a further understanding of the present disclosure, and constitute a part of the present application. The schematic embodiments of the present disclosure and their descriptions are used to explain the present disclosure, and do not constitute improper limitations to the present disclosure. In the drawings:

FIG. 1 is a flowchart of a method for determining parameters of an HVAC system according to an embodiment of the present disclosure;

FIG. 2 is a scenario diagram of a method for determining parameters of an HVAC system according to an embodiment of the present disclosure;

FIG. 3 is a schematic diagram of an HVAC system with an ultra wide band radar sensor according to an embodiment of the present disclosure;

FIG. 4 is a schematic diagram of communication of an HVAC system with an ultra wide band radar sensor according to an embodiment of the present disclosure;

FIG. 5 is a schematic diagram of an activity intensity factor for an individual provided according to an optional implementation of the present disclosure; and

FIG. 6 is a schematic diagram of an apparatus for determining parameters of an HVAC system according to an embodiment of the present disclosure.

### DETAILED DESCRIPTION OF THE INVENTION

To make those skilled in the art better understand the solutions of the present disclosure, the technical solutions in the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the scope of protection of the present disclosure.

It should be noted that the terms “first”, “second”, etc. in the specification and claims of the present disclosure and the above accompanying drawings are used to distinguish similar objects and are not necessarily used to describe a particular order or sequence. It is to be understood that the data used in this way may be interchanged under appropriate circumstances, such that the embodiments of the present disclosure described herein can be implemented in sequences other than those illustrated or described herein. In addition, the terms “include/comprise”, “have/has”, and any variation thereof are intended to cover non-exclusive inclusion. For example, processes, methods, systems, products or devices including a series of steps or units are not necessarily limited to clearly listed steps or units, but may include steps or units not clearly listed, or other steps or units inherent to these processes, methods, products or devices.

First, some nouns or terms that occur in the process of describing the embodiments of the present application are suitable for the following interpretations:

The Ultra Wide Band (UWB) radar sensor is a radar sensor using a UWB technology, where the UWB technology is a short distance wireless communication mode that transmits data at a rate of at least 100 Mbps within a range of 10 m. The UWB technology is a new technology based on direct transmission of narrow pulses, and is particularly applicable to hidden moving target detection and short distance data transmission due to its characteristics of low power consumption, good anti-jamming and anti-multipath capabilities, good penetration performance, etc.

The heating ventilation and air conditioning (HVAC) system is a control system that controls a temperature, a humidity, an air cleanliness, and an air circulation.

The ventilation efficiency, also known as a mixing efficiency, is defined as a ratio of an actual dilution air volume to a ventilation amount in a room.

The ventilation rate is a ventilation amount per unit area.

According to an embodiment of the present disclosure, an embodiment of a method for determining parameters of an HVAC system is provided. It should be noted that the steps shown in the flowchart in the accompanying drawings may be performed in a computer system such as a set of computer executable instructions, and while the logical order is shown in the flowchart, the steps shown or described may be performed in a different order than here in some cases.

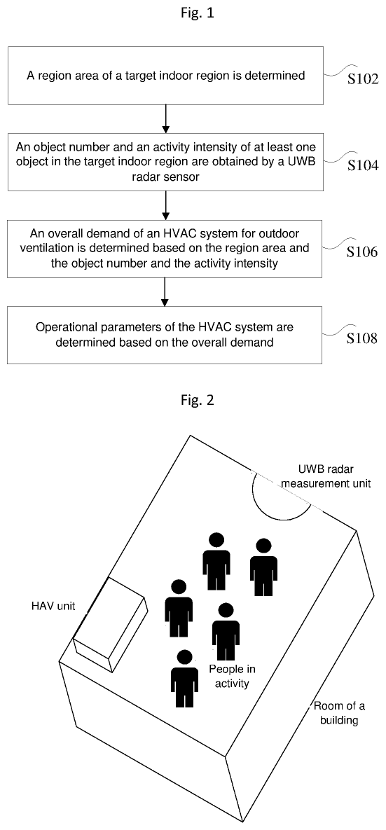

FIG. 1 is a flowchart of a method for determining parameters of an HVAC system according to an embodiment of the present disclosure. As shown in FIG. 1, the method includes steps below.

In step S102, a region area of a target indoor region is determined.

As at least one alternative embodiment, an executive subject of the method in this embodiment may be a terminal or a server configured to control the HVAC system. For example, when the method is applied to the terminal configured to control the HVAC system, i.e., when the method is applied to the terminal, control processing in a simple control scenario can be portably implemented; and for example, when the method is applied to the server, rich computing resources of the server or a larger and more accurate control model may be called, such that corresponding control may be performed on the HVAC system more accurately.

It is to be noted that there may be various types of terminals, such as a mobile terminal with a certain computing power and a fixed computer device with computing power. There may be various types of servers, such as a local server and a virtual cloud server. The server may be a single computer device or a computer cluster formed by integrating multiple computer devices together in terms of the computing power. Preferably, the executive subject of the method in this embodiment may be simply an air conditioning controller mounted in the HVAC system.

As at least one alternative embodiment, the target indoor region may be any region, in a building, needing to controlling indoor air according to the HVAC system. For example, the target indoor region may be indoor regions corresponding to various building sites such as hospitals, residential buildings, large shopping malls, and hotels. The region area of the target indoor region may be an area of a region the HVAC system actually needing to control, and may be a usable area with respect to a building area of the building.

In addition, the region area of the target indoor region may be determined in various ways, for example, using a measurement tool such as a tape measure, a laser rangefinder, or a radar. Units of measurement are ensured to be consistent (for example, all in meters), and then a length is multiplied by a width to obtain the region area of the indoor region. Certainly, other tools that directly measure the area may also be used for measurement, or tools that intelligently calculate the area directly after measuring a distance may be used to obtain the region area of the target indoor region.

In step S104, an object number and an activity intensity of at least one object in the target indoor region are obtained by a UWB radar sensor.

As at least one alternative embodiment, there may be various types of objects in the target indoor region, such as humans, animals, or other objects with requirements for temperature, humidity, ventilation, or other comforts. When the object number and the activity intensity of the at least one object in the target indoor region are obtained by the UWB radar sensor, the UWB radar sensor transmits and receives short pulse signals, and measures time delays and amplitudes of the signals to determine the object number and the activity intensity of the at least one target object, where the activity intensity is measured based on micromotion information such as a heartbeat of the target object. When the target object enters a monitoring range of the UWB radar sensor, the UWB radar sensor may detect a signal reflected by the target object and analyze the signal based on characteristics of the signal, so as to determine the object number and the activity intensity of the at least one target object. The UWB radar sensor may implement accurate statistics on the object number and the activity intensity of the indoor target objects by adjusting placement and parameters of the UWB radar sensor. It may detect target objects at different positions and distinguish different target objects, thereby counting the multiple target objects. The UWB radar sensor has high accuracy, strong real-time performance, and a capability of recognizing the multiple target objects, is applicable to application scenarios such as indoor target object statistics and motion state monitoring, has a secure detection mode, and does not infringe on privacies of the target objects. A system for monitoring the object number of the target objects and corresponding activity states based on the UWB radar sensor has advantages in real-time monitoring of the indoor target objects and an overall activity level, and high control reliability; and that wide band radar waves are insusceptible to environmental factors. Therefore, the HVAC system can be provided with accurate monitoring data. In addition, the HVAC system controls operation based on the data acquired by the UWB radar sensor. The objective of energy conservation can be effectively achieved due to the accurate acquired data, and the HVAC system can be provided with a fast real-time dynamic response due to the real-time transmission of the data by the UWB radar sensor, thereby adapting to sudden changes in loads such as cold, heat, and ventilation. The application of the UWB radar sensor technology helps to improve the energy efficiency of the building and reduce energy consumption and operating costs.

As at least one alternative embodiment, the object number in the target indoor region may refer to a number of individual objects included in the region, and the activity intensity of the at least one object in the target indoor region may refer to the activity intensity of individual objects included in the region. For example, when the object in the target indoor region is people, the object number is a number of people in the target indoor region, and the activity intensity is the activity intensity of people. The activity intensity may be characterized using various indicators, such as a heartbeat of people, and certainly, or other indicators, such as an oxygen consumption and a metabolic equivalent.

In step S106, an overall demand of an HVAC system for outdoor ventilation is determined based on the region area and the object number and the activity intensity.

As at least one alternative embodiment, the overall demand of the HVAC system for the outdoor ventilation may be determined based on the region area and the object number and the activity intensity in various ways, for example, the overall demand of the HVAC system for the outdoor ventilation may be determined based on a ventilation amount required for the target indoor region and indoor and outdoor ventilation efficiencies. Therefore, it is possible to first determine the ventilation amount required for the target indoor region based on the region area and the object number and the activity intensity, and then calculate an outdoor required ventilation amount based on the required indoor ventilation amount. The ventilation amount required for the indoor region varies depends on different region areas, different numbers of the indoor objects, and different activity intensities of the objects. The overall demand of the HVAC system for actual outdoor intake during operation may be obtained based on the calculated indoor ventilation amount.

As at least one alternative embodiment, the determining the overall demand of the HVAC system for the outdoor ventilation based on the required indoor ventilation amount includes: determining a ventilation efficiency based on an operating mode of the HVAC system; and determining the overall demand of the HVAC system for the outdoor ventilation based on the ventilation efficiency and the required indoor ventilation amount.

As at least one alternative embodiment, the ventilation efficiency is determined based on the operating mode of the HVAC system. The ventilation efficiency refers to a capability of a ventilation system to discharge indoor dirty air while providing fresh air. The HVAV control system has a cooling/heating mode. In the cooling mode, the ventilation system provides a comfortable indoor environment mainly by cooling and dehumidification. While in the heating mode, the ventilation system provides indoor comfort mainly by heating. Different modes have a certain impact on the ventilation efficiency. An air distribution mode refers to how to evenly distribute the fresh air into an indoor space. Common air distribution modes include mixed ventilation, exhaust ventilation, laminar flow ventilation, etc. Different air distribution modes have different impacts on the ventilation efficiency. Design and configuration of the ventilation system will also cause an impact on the ventilation efficiency. For example, factors such as fan power, air duct length and diameter, and selection of an air filter in the ventilation system will all affect the ventilation efficiency. For example, in a mixed air distribution system, the ventilation efficiency is 1.0 under the condition of cold air supply by a ceiling, and is 0.7 under the condition of warm air supply by a floor and air return by the ceiling. In a layered air distribution system, the ventilation efficiency is 1.05 under the condition of air supply by a floor with a vertical drop greater than or equal to 0.25% at a height of 1.4 m above the ground and air return by a ceiling at a height less than or equal to 5.5 m above the ground. In a personalized ventilation system, the ventilation efficiency is 1.4 under the condition of personalized air supply at a height of 1.4 m above the ground in combination with air supply by a ceiling and air return by the ceiling. Therefore, the ventilation efficiency is influenced by multiple factors such as the cooling/heating mode of the HVAC control system, the air distribution mode, and the design and configuration of the ventilation system. In order to improve the ventilation efficiency, it is required to select appropriate control mode and air distribution mode according to a specific situation and carry out reasonable system design and configuration.

For example, the overall demand for the outdoor ventilation=the required indoor ventilation amount/the ventilation efficiency.

The required indoor ventilation amount of the target indoor region may be determined based on the region area and the object number and the activity intensity in various ways, for example, the overall demand for the outdoor ventilation in one indoor region may be determined in a way of determining a static demand and a dynamic demand respectively. The static demand may be determined based on stationary objects in the indoor region, for example, based on the area of the indoor region, so as to obtain an area-based demand for the outdoor ventilation. The dynamic demand may be determined based on moving objects in the indoor region, for example, based on the object number and the activity intensity in the indoor region, so as to obtain an object-based demand for the outdoor ventilation.

Therefore, the required indoor ventilation amount of the target indoor region may be determined based on the region area and the object number and the activity intensity in the following processing way of: obtaining an area-based required first ventilation amount based on the region area; obtaining an object-based required second ventilation amount based on the object number and the activity intensity; and determining the required indoor ventilation amount of the target indoor region based on the first ventilation amount and the second ventilation amount.

In at least one alternative embodiment, the calculation of the required indoor ventilation amount may include the calculation of two parts as follows: the area-based required first ventilation amount and the object-based required second ventilation amount, where the first ventilation amount is a basic ventilation amount, and the basic indoor ventilation amount refers to a necessary ventilation amount for maintaining the freshness and humidity of the indoor air to be appropriate, determined based on the region area. The second ventilation amount is a ventilation amount for generation of pollutants. In addition to the basic ventilation amount, the indoor ventilation amount also needs to be increased based on the generation of the pollutants. The second ventilation amount is determined based on the object number and the activity intensity. The pollutants include harmful gases such as carbon dioxide and formaldehyde generated by breathing of the target objects, and smokes, odors, etc. generated by indoor activities. The ventilation amount for the generation of the pollutants may be calculated based on an amount of the pollutants generated and an indoor processing capacity. Therefore, the calculation of the required indoor ventilation amount needs to comprehensively consider the basic ventilation amount and the ventilation amount for the generation of the pollutants, to determine a total required indoor ventilation amount.

In at least one alternative embodiment, the area-based required first ventilation amount may also be obtained based on the region area in various ways. For example, the area-based required first ventilation amount may be calculated directly based on the area and the required ventilation amount per unit area. For example, the first ventilation rate corresponding to the region area is first determined; and the area-based required first ventilation amount is obtained based on the first ventilation rate and the region area.

As at least one alternative embodiment, the first ventilation rate varies depending on different region areas. The larger the indoor area is, the higher the ventilation rate is, indicating that the faster the air flows, the better the ventilation effect is. For example, the ventilation rate is 0.18 cfm/ft² in a region of 0.9 L/s*m², is 0.12 cfm/ft² in a region of 0.6 L/s*m², and is 0.06 cfm/ft² in a region of 0.3 L/s*m², and the area-based required first ventilation amount may be obtained based on the first ventilation rate and the region area.

In at least one alternative embodiment, the object-based required second ventilation amount may also be obtained based on the object number and the activity intensity in various ways. For example, a second ventilation rate corresponding to the object number is first determined; and the object-based required second ventilation amount is obtained based on the second ventilation rate and the object number and the activity intensity.

In this optional embodiment, the second ventilation rate varies depending on different numbers of indoor objects. Therefore, the object-based required second ventilation amount may be obtained based on the second ventilation rate corresponding to the object number of the indoor objects and the object number and the activity intensity. Usually, a ventilation demand for each object is considered to require a certain amount of the fresh air per hour, which is usually predetermined. In this embodiment, the object-based required second ventilation amount can be calculated more accurately based on the activity intensity of each object by introducing the second ventilation rate corresponding to the object number and the activity intensity corresponding to each object.

In at least one alternative embodiment, the activity intensity of the at least one object in the target indoor region may be obtained by the UWB radar sensor through accurate heartbeat cloud computing. For example, the target heart rate of the object in the target indoor region by the UWB radar sensor may be determined; and the activity intensity of the at least one object in the target indoor region is determined based on the target heart rate and a predetermined reference heart rate. When the activity intensity of the at least one object is determined based on the target heart rate and the predetermined reference heart rate, the activity intensity of the at least one object may be determined based on comparison between the target heart rates and the predetermined reference heart rate. For example, the activity intensity of the at least one object may be determined based on a ratio of the target heart rate to the predetermined reference heart rate, a difference value between the target heart rate and the predetermined reference heart rate, or a ratio of the difference value to the predetermined reference heart rate. A specific calculation way may be flexibly selected according to a requirement.

For example, it is possible to first obtain the target heart rate of the object in the target indoor region by the UWB radar sensor and then determine the activity intensity of the at least one object in the region based on the target heart rate and the predetermined reference heart rate. The heart rates may reflect the activity intensity of the at least one object. The heart rate is in a linear relationship with the activity intensity in a certain range (100-180 beats/min), that is, the higher the heart rate is, the greater the activity intensity is.

In step S108, operational parameters of the HVAC system are determined based on the overall demand.

As at least one alternative embodiment, the operational parameters of the HVAC system are determined based on the overall demand. If the ventilation amount is too large, too much outdoor air will be introduced, and a heat load brought whereby needs to be eliminated by a larger cooling capacity provided by the HVAC system. If the ventilation amount is too small, the indoor air quality will decrease, and the old air will increase the discomfort of a human body. Therefore, the appropriate ventilation amount needs to be controlled, and then the operational parameters of the HVAC system are determined, to implement precise control on the HVAC system.

Through the above steps, the operational parameters of the HVAC system are accurately determined, thereby achieving the effects of avoiding energy waste while satisfying the comfort of the target objects, and solving the technical problem that the operational parameters of the HVAC system cannot be accurately determined on demand.

Based on the above embodiments and optional embodiments, an optional implementation is further provided.

In the process of analyzing the above problems in related art, it is found that people in a building region and activities thereof are key factors affecting energy conservation control. Therefore, real-time dynamic adjustment of the HVAC system based on the object number and activity levels of people can effectively reduce energy consumption.

When indoor people in the building are detected, the following several technical solutions capable of performing dynamic control on the HVAC system may be attempted according to different methods for detecting people.

In a solution of control based on a motion or vision sensor and image recognition, motions and positions of people are detected using a camera or the sensor mounted inside the building. The object number and the position information of people may be recognized in real time through an image recognition algorithm, and the operating mode of the HVAC system is adjusted based on the positions and activity statuses of people. However, this solution has a problem of sensitivity to environmental conditions, for example, lighting, smokes, etc., may affect the image quality and the recognition accuracy. In addition, there is also a problem of personal privacy security.

In a solution of control based on CO2 concentration, the CO2 concentration in the building is monitored by mounting a CO2 sensor. People will produce CO2 during breathing, and therefore the CO2 concentration may be used as an indicator of whether there are people. By measuring a change in the CO2 concentration, it is possible to infer the object number of people and adjust the HVAC system accordingly. However, the CO2 concentration is in a nonlinear relationship with the object number of people, and is affected by other factors, such as ventilation and air quality, such that calibration and adjustment are required to improve accuracy.

In a solution of control based on an infrared biosensor, thermal radiation of the human body is detected using the infrared biosensor, and it is determined whether there are people by detecting body temperatures of people. Such method is sensitive to moving people, and may be used to determine whether there are people moving in the region, but cannot provide accurate the information on the object number of people. In addition, the detection accuracy is low for stationary people or multiple people who approach and move together.

Therefore, the control based on image recognition has the following problems and drawbacks: the imaging technology depends highly on environmental conditions, such as lighting, smokes, vibration, and obstacles. When the environmental conditions are harsh, the image quality is affected, thereby reducing the reliability of control. In addition, an image recognition technology may also involve the problem of privacy security. The technology for detecting people based on the CO2 concentration has the following problems: the CO2 concentration is an indirect detection technology, is affected by multiple factors, and has poor reliability. The CO2 concentration is in the nonlinear relationship with the object number of people, such that a large amount of on-site calibration is required. The infrared biosensor based technology has the following problems: when multiple objects approach and move together, the object number of individuals cannot be accurately distinguished, resulting in low detection accuracy. This technology can only detect the moving objects and is insensitive to detection of the static objects. Therefore, in practical application, the infrared biosensor technology is mainly used to determine whether there are people in the region, but cannot provide accurate information on the object number of people.

In summary, all of these technical solutions have certain limitations and problems in implementing the dynamic control on the HVAC system. Therefore, in this embodiment of the present disclosure, the combination of an energy conservation control technology for the HVAC system based on the ultra wide band radar sensor provides a more efficient, accurate, and reliable solution, which overcomes some limitations of the above technical solutions.

In an example implementation of the present disclosure, an energy conservation control method for the HVAC system based on the ultra wide band (UWB) radar sensor is provided. In this method, the ultra wide band radar technology is combined with the control on the HVAC system to implement on-demand control and achieve the objective of energy conservation.

In an optional implementation of the present disclosure, a system for monitoring the object number and the activity states of people based on the UWB radar sensor aims to monitor the object number of indoor people and the overall activity level in real time, so as to optimize the operation of the HVAC system and achieve the objective of energy conservation.

The UWB radar sensor is an infrared radar sensor based on an ultra wide band technology. Compared with the conventional infrared biosensor, it has a higher measurement accuracy and a wider detection range. By using the UWB radar sensor, accurate detection and tracking of indoor people may be implemented, including statistics on the object number of people and analysis on the activity states.

In an optional implementation of the present disclosure, the positions, movement trajectories, and corresponding activity states of indoor people may be obtained in real time by the high-precision distance measurement capability and the real-time monitoring function of the UWB radar sensor mounted inside the building. Based on the data, the HVAC system may analyze changes on the object number of indoor people and the overall activity level in real time, and apply the information to optimization control on the HVAC system.

Through integration with the HVAC system, the HVAC system may dynamically adjust the operational parameters thereof, such as temperature, humidity, and wind speed, based on the changes in the object number and the activity levels of indoor people, to meet actual requirements. This may avoid energy waste in a region without people, provide the comfortable indoor environment, and achieve the effect of energy conservation.

In summary, the system for monitoring the object number of people and the corresponding activity states based on the UWB radar sensor has advantages in real-time monitoring of the object number of indoor people and the overall activity level, and the objective of energy conservation can be achieved by optimizing the operation of the HVAC system. The application of this technology helps to improve the energy efficiency of the building and reduce the energy consumption and the operating costs.

It is to be noted that in an optional implementation of the present disclosure, that the target object is people is used as an example, and that the target indoor region is a room in the building is used as example for description.

FIG. 2 is a schematic diagram of an HVAC system mounted with an ultra wide band radar sensor provided according to an optional implementation of the present disclosure. As shown in FIG. 2, the system includes a UWB radar measurement unit (the same as the UWB radar sensor) and an HVAC unit. In the room of the building, the HVAC unit of the system provides corresponding cooling, heating, humidity, ventilation, and other adjustment functions to meet the comfort requirements of people in activity, and the UWB radar measurement unit monitors an environment in the entire room of the building. The UWB radar measurement unit is mounted at an appropriate indoor position according to a requirement. These units should be able to cover the region that needs to be monitored and accurately detect the object number and the activity intensities of people. Two units are connected through a wired or wireless communication bus, to transmit data to each other. Data transmission includes wired and wireless transmission. The wired transmission includes commonly used RS-485, the Ethernet, a USB, etc. The wireless transmission includes WIFI, Bluetooth, Zigbee, Lora radio frequency, etc.

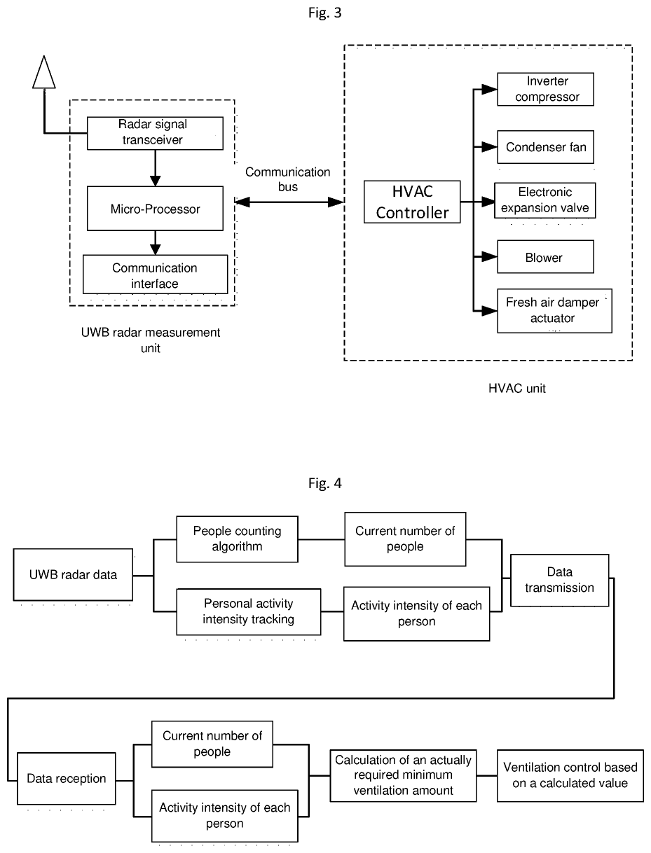

FIG. 3 is a schematic diagram of communication of an HVAC system including an ultra wide band radar sensor provided according to an optional implementation of the present disclosure. As shown in FIG. 3, the system includes a UWB radar measurement unit and an HVAC unit, where the UWB radar measurement unit includes a radar signal transceiver, a micro-processor, and a communication interface. The radar signal transceiver is configured to acquire signals; the micro-processor performs certain algorithmic processing on the signals to obtain the object number and the activity intensities of the target objects, and transmits the object number and the activity intensities of the target objects to the HVAC unit for parameter control through the communication interface and the communication bus; and the UWB radar measurement unit transmits the monitored data on the object number and the activity intensities of people to the HVAC unit. The data will be used as an input to calculate and adjust control parameters of ventilation, cooling, etc. The HVAC unit includes an HVAC controller, an inverter compressor, a condenser fan, an electronic expansion valve, a blower, and a fresh air damper actuator. In the HVAC unit, a size of a gap between a valve needle and a valve body of the electronic expansion valve is controlled to achieve the effects of throttling and control on flow of a refrigerant. Refrigeration output of the HVAC system is implemented through the condenser fan by controlling a speed of a motor in the inverter compressor. In the HVAC unit, the adjustment of the ventilation amount is implemented by controlling the fresh air damper actuator and a speed of the blower. The performance and effect of the system are regularly monitored, and necessary optimization and adjustment are made according to an actual situation.

FIG. 4 is a schematic diagram that an HVAC system including an ultra wide band radar sensor implements adjustment of a ventilation amount provided according to an optional implementation of the present disclosure. As shown in FIG. 4, the adjustment of the ventilation amount may be implemented under the control of software, where the control process of the software is as follows:

A people counting algorithm is executed through data signals acquired by the UWB radar sensor to obtain a current number of people; an activity intensity of each person is obtained through personal activity intensity tracking; the obtained current number of people and activity intensity of each person are transmitted through data transmission to the HVAC control system for data reception; a required actual minimum ventilation amount for control is calculated based on the received parameters, i.e., current number of people and activity intensity of each person; and ventilation control is performed on the HVAC system based on the calculated minimum ventilation amount.

The heart rate may reflect the motion intensity and is in the linear relationship with the motion intensity in a certain range (100-180 beats/min). Therefore, when the object number of people in the region and the activity intensity of each person are known, a required optimal ventilation amount may be calculated.

The minimum ventilation amount is calculated. If the ventilation amount is too large, too much outdoor air will be introduced, and a heat load brought whereby needs to be eliminated by a larger cooling capacity provided by the HVAC system. If the ventilation amount is too small, the indoor air quality will decrease, and the old air will increase the discomfort of a human body. Therefore, the appropriate ventilation amount needs to be controlled. For the calculation of the ventilation amount, reference may be made to the following specifications:

$$Vbz = {R}_{p} \times {P}_{z} + {R}_{a} \times {A}_{z} ;$$

Vbz=required indoor ventilation amount;
Rₚ=ventilation rate based on number of people, in cfm/p;
P_{z}=number of people in region;
Rₐ=ventilation rate based on area, in cfm/ft²; and
A_{z}=region area, in ft².

For Rₚ and Rₐ, reference is made to Table 1:

TABLE 1
Minimum Ventilation Rate of Activity Region For People

| | Fresh air | | Fresh air | | Default | | |
|---|---|---|---|---|---|---|---|
| | ventilation rate | | ventilation rate Rₐ | | value | | |
| | Rₚ required for | | required for | | Density of | | |
| | outdoor people | | outdoor region | | people | | |
| | | L/s · | cfm/ | | #/1000 ft² | Air | Reference |
| Region category | cfm/person | person | ft² | L/s · m² | or #/100 m² | level | (6.2.6.1.4) |
| Animal facilities | | | | | | | |
| Animal examination | 10 | 5 | 0.12 | 0.6 | 20 | 2 | |
| room (veterinary office) | | | | | | | |
| Animal imaging | 10 | 5 | 0.18 | 0.9 | 20 | 3 | |
| (MRICT/PET) | | | | | | | |
| Animal operating room | 10 | 5 | 0.18 | 0.9 | 20 | 3 | |
| Animal postoperative | 10 | 5 | 0.18 | 0.9 | 20 | 3 | |
| recovery room | | | | | | | |
| Animal preparation | 10 | 5 | 0.18 | 0.9 | 20 | 3 | |
| room | | | | | | | |
| Animal operating room m | 10 | 5 | 0.18 | 0.9 | 20 | 3 | |
| Animal surgical scrub | 10 | 5 | 0.18 | 0.9 | 20 | 3 | |
| Large animal feeding | 10 | 5 | 0.18 | 0.9 | 20 | 3 | |
| room | | | | | | | |
| Autopsy | 10 | 5 | 0.18 | 0.9 | 20 | 3 | |
| Small animal cage | 10 | 5 | 0.18 | 0.9 | 20 | 3 | |
| (static cage) | | | | | | | |
| Small animal cage | 10 | 5 | 0.18 | 0.9 | 20 | 3 | |
| (ventilated cage) | | | | | | | |
| Correctional facilities | | | | | | | |
| Waiting hall | 7.5 | 3.8 | 0.06 | 0.3 | 50 | 2 | |
| Cell | 5 | 2.5 | 0.12 | 0.6 | 25 | 2 | |
| Rest room | 5 | 2.5 | 0.06 | 0.3 | 30 | 1 | |
| Guard station | 5 | 2.5 | 0.06 | 0.3 | 15 | 1 | |
| Educational facilities | | | | | | | |
| Art room | 10 | 5 | 0.18 | 0.9 | 20 | 2 | |
| Classroom (ages 5 to | 10 | 5 | 0.12 | 0.6 | 25 | 1 | |
| 8) | | | | | | | |
| Classroom (age 9+) | 10 | 5 | 0.12 | 0.6 | 35 | 1 | |
| Computer lab | 10 | 5 | 0.12 | 0.6 | 25 | 1 | |
| Daycare ward | 10 | 5 | 0.18 | 0.9 | 25 | 3 | |
| Daycare (to age 4) | 10 | 5 | 0.18 | 0.9 | 25 | 2 | |
| Lecture room | 7.5 | 3.8 | 0.06 | 0.3 | 66 | 1 | √ |
| Lecture hall (fixed | 7.5 | 3.8 | 0.06 | 0.3 | 150 | 1 | √ |
| seats) | | | | | | | |
| Library | 5 | 2.5 | 0.12 | 0.6 | 10 | | |
| Media center | 10 | 5 | 0.12 | 0.6 | 25 | 1 | |
| Multi-purpose | 7.5 | 3.8 | 0.06 | 0.3 | 100 | 1 | √ |
| assembly | | | | | | | |
| Music/drama/dance | 10 | 5 | 0.06 | 0.3 | 35 | 1 | √ |
| Science lab | 10 | 5 | 0.18 | 0.9 | 25 | 2 | |
| University/college lab | 10 | 5 | 0.18 | 0.9 | 25 | 2 | |
| Wood/metal store | 10 | 5 | 0.18 | 0.9 | 20 | 2 | |

While different reference values for Rₚ have been suggested for different places, a relationship between activity levels of human bodies in a same place and ventilation demands is not detailed in the above standards. On this basis, impact factors for actual activity levels are introduced to supplement an original formula:

$${V}_{bz} = {\sum }_{i = 0}^{P} {R}_{P} \times {A}_{P ( i )} + {R}_{A} \times {A}_{Z} ;$$

AP(i)=activity intensity factor for each individual;
P: Number of people.

FIG. 5 is a schematic diagram of an activity intensity factor for an individual provided according to an optional implementation of the present disclosure. As shown in FIG. 5, a heart rate of the individual is obtained from data detected by the radar sensor, and a personal motion intensity may be calculated in combination with a preset heart rate reference value that may be 80 beats/min.

After V_{bz} is calculated, the overall demand for the outdoor ventilation may be further calculated.

$$Voz = {V}_{bz} / {E}_{z} ;$$

Voz=total outdoor ventilation demand;
   Ez=ventilation efficiency, which varies depending on the cooling/heating mode or the air distribution mode, and for which reference may be made to Table 2:

TABLE 2
Regional Air Supply Efficiency

| Air supply mode | Ez |
|---|---|
| Good mixed air distribution system | |
| Cold air is supplied by a ceiling | 1.0 |
| Warm air is supplied by a ceiling | 1.0 |
| and air is returned by a floor | |
| Warm air with a temperature higher | 0.8 |
| than a space temperature by 15° F. (8° C.) | |
| or above is supplied by a ceiling | |
| and air is returned by the ceiling | |
| A temperature of warm air supplied by | 0.8 |
| a ceiling is lower than an average | |
| space temperature by 15° F. (8° C.), | |
| and an air supply jet velocity is less than | |
| 150 fpm (0.8 m/s) within a distance 4.5 ft | |
| (1.4 m) from a floor and the ceiling | |
| A temperature of warm air supplied by | 1.0 |
| a ceiling is lower than an average | |
| space temperature by 15° F. (8° C.), and | |
| an air supply velocity is equal to or | |
| greater than 150 fpm (0.8 m/s) and an upper | |
| limit within a distance 4.5 ft (1.4 m) | |
| from a floor | |
| Warm air is supplied by a floor and | 1.0 |
| air is returned by the floor | |
| Warm air is supplied by a floor and | 0.7 |
| air is returned by a ceiling | |
| A supplementary supply outlet is located | 0.8 |
| at a position from an air outlet, a | |
| water return inlet, or more than half a | |
| length of a space between the air outlet | |
| and the water return inlet | |
| A supplementary supply outlet is away | 0.5 |
| from an air outlet, a water return inlet, | |
| or less than half a length of a space | |
| between the air outlet and the water | |
| return inlet | |
| Layered air distribution system | |
| Ground cold air supply with a vertical | 1.05 |
| range greater than or equal to 60 fpm | |
| (0.25 m/s) at a height of 4.5 ft (1.4 m) is | |
| above a floor and a return height of a | |
| ceiling is less than or equal to 18 ft | |
| (5.5 m) of the floor | |
| Ground cold air supply with a vertical | 1.2 |
| range less than 60 fpm (0.25 m/s) at a | |
| height of 4.5 ft (1.4 m) is above a floor | |
| and a return height of a ceiling is less | |
| than or equal to 18 ft (5.5 m) of the floor | |
| Ground cold air supply with a vertical | 1.5 |
| range less than 60 fpm (0.25 m/s) at a | |
| height of 4.5 ft (1.4 m) is above a floor | |
| and a return height of a ceiling is | |
| greater than 18 ft (5.5 m) of the floor | |
| Personalized ventilation system | |
| Personalized air at a height of 4.5 ft (1.4 m) | 1.40 |
| from a floor is combined with cold | |
| air supply by a ceiling and air return by the ceiling | |
| Personalized air at a height of 4.5 ft | 1.40 |
| (1.4 m) from a floor is combined with | |
| warm air supply by a ceiling and air | |
| return by the ceiling | |
| Personalized air at a height of 4.5 ft (1.4 m) | 1.20 |
| above a floor is combined with a | |
| layered air distribution system (equipped | |
| with a non-aspirating floor air supply | |
| apparatus and a ceiling air return apparatus) | |
| Personalized air at a height of 4.5 ft (1.4 m) | 1.50 |
| above a floor is combined with a | |
| layered air distribution system equipped | |
| with an aspirating floor air supply | |
| apparatus and a ceiling air return apparatus | |

In an optional implementation of the present disclosure, a millimeter wave radar technology is close to a UWB technology, and an operating frequency thereof is dozens of GHz. Therefore, the millimeter wave radar technology may also be used to replace the UWB technology to implement the control on the HVAC system. The two technologies are comparable in measurement principle and performance, but the UWB technology is more cost-effective.

The entire solution is described in detail below in combination with the optional implementation.

In mounting the UWB radar sensor, the UWB radar sensor is mounted in an appropriate indoor position according to a requirement. The mounted UWB radar sensor should be able to cover the region that needs to be monitored and accurately detect the object number and the activity intensities of people.

In connecting the UWB radar sensor to the HVAC controller, the UWB radar sensor is connected to the HVAC controller. The connection may be carried out in a wired or wireless transmission mode, such as RS-485, the Ethernet, a USB, WIFI, Bluetooth, Zigbee, and Lora radio frequency.

In transmitting the monitored data, the UWB radar sensor transmits the monitored data on the number and the activity intensities of people to the HVAC controller. The data will be used as an input to calculate and adjust control parameters of ventilation, cooling, etc.

In response of the HVAC controller, the HVAC controller, after receiving the data from the UWB radar sensor, performs corresponding control operations based on set algorithms and rules. The control includes adjusting the ventilation amount, the cooling capacity, etc. based on the number and the activity intensities of people to meet the energy conservation and comfort requirements.

In monitoring and optimization, the performance and effect of the system are regularly monitored, and necessary optimization and adjustment are made according to an actual situation. The process includes verifying the accuracy and reliability of the UWB radar sensor and making appropriate parameter adjustment based on the relationship between the actual activity levels and the ventilation demands.

Through the above steps, simple system installation and operation can be implemented in an optional implementation of the present disclosure, and accurate monitoring of the UWB radar sensor and effective response of the HVAC controller can be ensured, thereby achieving the objective of energy conservation and comfort.

In an optional implementation of the present disclosure, the UWB radar sensor based control has certain advantages over the CO2 or visual image based control, especially in terms of accuracy and real-time responsiveness.

In accuracy, the UWB radar sensor can more accurately make statistics on the number of people and further detect the micromotion information, such as heartbeats. After corresponding verification and application, the credibility is high. The activity levels of people may be known more comprehensively by detecting the micromotion information such as heartbeats, thereby more accurately reflecting the ventilation and cooling requirements in the current activity region.

In real-time responsiveness, the UWB radar sensor based detection can implement minute-level response. In contrast, the CO2 based response typically takes more than 10 minutes. This means that the control system based on the UWB radar sensor may faster sense changes in activities of people and adjust ventilation and cooling parameters in a timely manner, to meet real-time energy conservation requirement.

In on-demand control optimization, the control based on the number of people and the activity intensities of individuals can more accurately reflect the ventilation and cooling requirements of the current activity region. This technology may implement almost ideal on-demand control in combination with the number of people and the micromotion information such as heartbeats, to maximize the effect of energy conservation.

In summary, the technology for detection based on the number and the activity intensities of people from the UWB radar sensor can provide more accurate and real-time data, to optimize the control on the HVAC system. The almost ideal on-demand control may be implemented through this technology, thereby achieving the best effect of energy conservation.

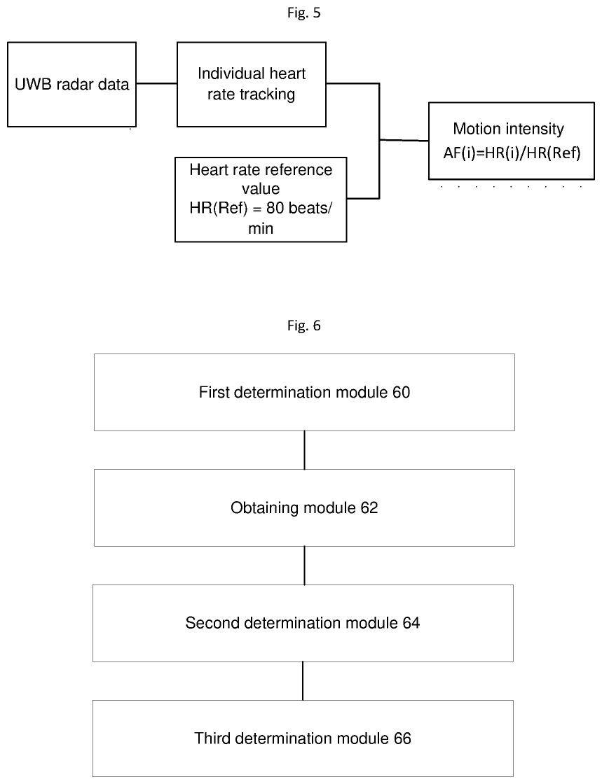

According to another aspect of the present disclosure, there is provided an apparatus for determining parameters of an HVAC system. FIG. 6 is a schematic diagram of an apparatus for determining parameters of an HVAC system according to an embodiment 2 of the present disclosure. As shown in FIG. 6, the apparatus includes a first determination module 60, an obtaining module 62, a second determination module 64, and a third determination module 66. The apparatus is described in detail below.

The first determination module 60 is configured to determine a region area of a target indoor region; the obtaining module 62 is connected to the first determination module 60 and configured to obtain an object number and an activity intensity of at least one object in the target indoor region by a UWB radar sensor; the second determination module 64 is connected to the obtaining module 62 and configured to determine an overall demand of an HVAC system for outdoor ventilation based on the region area and the object number and the activity intensity; and the third determination module 66 is connected to the second determination module 64 and configured to determine operational parameters of the HVAC system based on the overall demand.

In an embodiment of the present disclosure, a computer-readable storage medium is further provided, including a stored executable program, where the executable program, when run, controls a device where the computer-readable storage medium is located to perform any one of the above methods for determining parameters of an HVAC system.

In an embodiment of the present disclosure, an electronic device is further provided, including: a memory storing an executable program; and a processor configured to run the program, where the program, when run, performs any one of the above methods for determining parameters of an HVAC system.

The sequence numbers of the above embodiments of the present disclosure are only for description and do not represent the advantages or disadvantages of the embodiments.

In the above embodiments of the present disclosure, the description of each embodiment has its own emphasis. For the part not detailed in an embodiment, reference may be made to related descriptions of other embodiments.

In the several embodiments provided in the present application, it should be understood that the technical content disclosed may be implemented in other ways. The device embodiment described above is merely schematic. For example, the division of units may be a logical function division. During actual implementation, there may be other division ways. For example, a plurality of units or components may be combined or integrated to another system, or some features may be ignored or not implemented. In addition, mutual coupling, direct coupling or communication connection shown or discussed may be indirect coupling or communication connection of units or modules through some interfaces, and may be in electrical or other forms.

Units described as separate components may or may not be physically separated, and components shown as units may or may not be physical units, that is, may be located in one place, or may be distributed to multiple units. Some or all of the units may be selected according to actual needs to achieve the objective of the solution in this embodiment.

In addition, each functional unit in each embodiment of the present disclosure may be integrated into one processing unit, each unit may exist physically alone, or two or more units may be integrated into one unit. The above integrated unit may be implemented in the form of hardware or a software functional unit.

The integrated unit, if implemented in the form of the software functional unit and sold or used as a stand-alone product, may be stored in one computer-readable storage medium. Based on such understanding, the technical solution of the present application essentially, a part that contributes to the prior art, or all or part of the technical solution may be embodied in the form of a software product, and the computer software product is stored in one storage medium and includes multiple instructions for making one computer device (which may be a personal computer, a server, or a network device) perform all or part of the steps of the method in each embodiment of the present disclosure. The foregoing storage medium includes a U disk, a read-only memory (ROM), a random access memory (RAM), a mobile hard disk, a magnetic disk, or a compact disc that may store program codes.

The above description is only the preferred implementation of the present disclosure. It should be pointed out that several improvements and modifications may be made by those of ordinary skill in the art without departing from the principle of the present disclosure, and these improvements and modifications are also regarded as the scope of protection of the present disclosure.

1. A method for determining parameters of a Heating Ventilation and Air Conditioning (HVAC) system, comprising:
determining a region area of a target indoor region;
obtaining an object number and an activity intensity of at least one object in the target indoor region by an Ultra Wide Band (UWB) radar sensor;
determining an overall demand of the HVAC system for outdoor ventilation based on the region area and the object number and the activity intensity of the at least one object; and
determining operational parameters of the HVAC system based on the overall demand.

2. The method as claimed in claim 1, wherein the determining an overall demand of the HVAC system for outdoor ventilation based on the region area and the object number and the activity intensity of the at least one object comprises:
determining a required indoor ventilation amount of the target indoor region based on the region area and the object number and the activity intensity of the at least one object; and
determining the overall demand of the HVAC system for the outdoor ventilation based on the required indoor ventilation amount.

3. The method as claimed in claim 2, wherein the determining the overall demand of the HVAC system for the outdoor ventilation based on the required indoor ventilation amount comprises:
determining a ventilation efficiency based on an operating mode of the HVAC system; and
determining the overall demand of the HVAC system for the outdoor ventilation based on the ventilation efficiency and the required indoor ventilation amount.

4. The method as claimed in claim 2, wherein the determining a required indoor ventilation amount of the target indoor region based on the region area and the object number and the activity intensity of the at least one object comprises:
obtaining an area-based required first ventilation amount based on the region area;
obtaining an object-based required second ventilation amount based on the object number and the activity intensity of the at least one object; and
determining the required indoor ventilation amount of the target indoor region based on the first ventilation amount and the second ventilation amount.

5. The method as claimed in claim 4, wherein the obtaining an area-based required first ventilation amount based on the region area comprises:
determining a first ventilation rate corresponding to the region area; and
obtaining the area-based required first ventilation amount based on the first ventilation rate and the region area.

6. The method as claimed in claim 4, wherein the obtaining an object-based required second ventilation amount based on the object number and the activity intensity of the at least one object comprises:
determining a second ventilation rate corresponding to the object number; and
obtaining the object-based required second ventilation amount based on the second ventilation rate and the object number and the activity intensity.

7. The method as claimed in claim 1, wherein the obtaining an activity intensity of at least one object in the target indoor region by a UWB radar sensor comprises:
obtaining a target heart rate of the at least one object in the target indoor region by the UWB radar sensor; and
determining the activity intensity of the at least one object in the target indoor region based on the target heart rate and a predetermined reference heart rate.

8. The method as claimed in claim 2, wherein the obtaining an activity intensity of at least one object in the target indoor region by a UWB radar sensor comprises:
obtaining a target heart rate of the at least one object in the target indoor region by the UWB radar sensor; and
determining the activity intensity of the at least one object in the target indoor region based on the target heart rate and a predetermined reference heart rate.

9. The method as claimed in claim 3, wherein the obtaining an activity intensity of at least one object in the target indoor region by a UWB radar sensor comprises:
obtaining a target heart rate of the at least one object in the target indoor region by the UWB radar sensor; and
determining the activity intensity of the at least one object in the target indoor region based on the target heart rate and a predetermined reference heart rate.

10. The method as claimed in claim 4, wherein the obtaining an activity intensity of at least one object in the target indoor region by a UWB radar sensor comprises:
obtaining a target heart rate of the at least one object in the target indoor region by the UWB radar sensor; and
determining the activity intensity of the at least one object in the target indoor region based on the target heart rate and a predetermined reference heart rate.

11. The method as claimed in claim 5, wherein the obtaining an activity intensity of at least one object in the target indoor region by a UWB radar sensor comprises:
obtaining a target heart rate of the at least one object in the target indoor region by the UWB radar sensor; and
determining the activity intensity of the at least one object in the target indoor region based on the target heart rate and a predetermined reference heart rate.

12. The method as claimed in claim 6, wherein the obtaining an activity intensity of at least one object in the target indoor region by a UWB radar sensor comprises:
obtaining a target heart rate of the at least one object in the target indoor region by the UWB radar sensor; and
determining the activity intensity of the at least one object in the target indoor region based on the target heart rate and a predetermined reference heart rate.

13. A computer-readable storage medium, comprising a stored executable program, wherein the executable program, when run, controls a device where the computer-readable storage medium is located to perform following actions:
determining a region area of a target indoor region;
obtaining an object number and an activity intensity of at least one object in the target indoor region by an Ultra Wide Band (UWB) radar sensor;
determining an overall demand of the HVAC system for outdoor ventilation based on the region area and the object number and the activity intensity of the at least one object; and
determining operational parameters of the HVAC system based on the overall demand.

14. The computer-readable storage medium as claimed in claim 13, wherein the determining an overall demand of the HVAC system for outdoor ventilation based on the region area and the object number and the activity intensity of the at least one object comprises:
determining a required indoor ventilation amount of the target indoor region based on the region area and the object number and the activity intensity of the at least one object; and
determining the overall demand of the HVAC system for the outdoor ventilation based on the required indoor ventilation amount.

15. The computer-readable storage medium as claimed in claim 14, wherein the determining the overall demand of the HVAC system for the outdoor ventilation based on the required indoor ventilation amount comprises:
determining a ventilation efficiency based on an operating mode of the HVAC system; and
determining the overall demand of the HVAC system for the outdoor ventilation based on the ventilation efficiency and the required indoor ventilation amount.

16. The computer-readable storage medium as claimed in claim 14, wherein the determining a required indoor ventilation amount of the target indoor region based on the region area and the object number and the activity intensity of the at least one object comprises:
obtaining an area-based required first ventilation amount based on the region area;
obtaining an object-based required second ventilation amount based on the object number and the activity intensity of the at least one object; and
determining the required indoor ventilation amount of the target indoor region based on the first ventilation amount and the second ventilation amount.

17. The computer-readable storage medium as claimed in claim 16, wherein the obtaining an area-based required first ventilation amount based on the region area comprises:
determining a first ventilation rate corresponding to the region area; and
obtaining the area-based required first ventilation amount based on the first ventilation rate and the region area.

18. The computer-readable storage medium as claimed in claim 16, wherein the obtaining an object-based required second ventilation amount based on the object number and the activity intensity of the at least one object comprises:
determining a second ventilation rate corresponding to the object number; and
obtaining the object-based required second ventilation amount based on the second ventilation rate and the object number and the activity intensity.

19. The computer-readable storage medium as claimed in claim 13, wherein the obtaining an activity intensity of at least one object in the target indoor region by a UWB radar sensor comprises:
obtaining a target heart rate of the at least one object in the target indoor region by the UWB radar sensor; and
determining the activity intensity of the at least one object in the target indoor region based on the target heart rate and a predetermined reference heart rate.

20. An electronic device, comprising:
a memory storing an executable program; and
a processor configured to run the program, wherein the program, when run, performs following actions:
determining a region area of a target indoor region;
obtaining an object number and an activity intensity of at least one object in the target indoor region by an Ultra Wide Band (UWB) radar sensor;
determining an overall demand of the HVAC system for outdoor ventilation based on the region area and the object number and the activity intensity of the at least one object; and
determining operational parameters of the HVAC system based on the overall demand.
